(19) United States
(12) Patent Application Publication
(10) Pub. No.: US 2010/0110892 A1
(43) Pub. Date: May 6, 2010

(54) NETWORK SYSTEM, ADJUSTING METHOD OF DATA TRANSMISSION RATE AND COMPUTER PROGRAM PRODUCT THEREOF

(75) Inventors: Chih-Chun Lai, Taipei City 104 (TW); Hsu-Feng Hsiao, Hsinchu City (TW); Sheng-Shuen Wang, Hsinchu City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/353,495

(22) Filed: Jan. 14, 2009

(30) Foreign Application Priority Data
Nov. 6, 2008 (TW) 097142909

(51) Int. Cl. H04L 12/26

(52) U.S. Cl. 370/235

(57) ABSTRACT

A network system, an adjusting method of a data transmission rate of the network system, and a computer program product thereof are disclosed. The network system comprises a transmitting apparatus and a receiving apparatus. The transmitting apparatus is configured to transmit a packet train at a transmission rate to the receiving apparatus. The receiving apparatus is configured to receive the packet train and to compute at least one factor related to the received packet train to evaluate whether the transmission rate is suitable for the network system. The receiving apparatus is further configured to transmit an adjustment signal according to the at least one factor, such that the transmitting apparatus appropriately adjusts the transmission rate in response to the adjusting signal.

This application claims the benefit of priority based on Taiwan Patent Application No. 097142909, filed on Nov. 6, 2008, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a network system, an adjusting method of a data transmission rate and a computer program product thereof. More particularly, the present invention relates to a network system, an adjusting method and a computer program product thereof that are all capable of increasing/decreasing the data transmission rate according to link conditions.

2. Descriptions of the Related Art

With the evolution of network technologies, multimedia streaming transmission has now become one of the hottest applications of the network, such as Internet Protocol (IP) cameras for real-time audio and video communications, IP telephones for on-line chatting or a slingbox/location-free TV for watching video programs.

In reference to FIG. 1, when multimedia streaming transmission is adopted in an end-to-end network system (for example, a network monitoring system 1 comprising a webcam 11, a wireless/wired network 13 and a monitor host 15), the webcam 11 (i.e., a transmitting end) of the prior art typically transmits an image or voice data in a packet train 10 to the monitor host (i.e., a receiving end) 15 via the wireless/wired network 13 at a fixed data transmission rate.

Generally, the webcam 11 of the prior art sets a fixed data transmission rate for transmitting the packet train according to an available bandwidth in the wireless/wired network 13, and then compresses the data according to the fixed data transmission rate. If there are more devices (transmitting ends) 17 attempting to transmit data to other host computers (receiving ends) 19 via the wireless/wired network 13, the heavy cross traffic in the wireless/wired network 13 may cause a significant decrease in the available bandwidth thereof In this case, if the webcam 11 still compresses data according to the predetermined fixed data transmission rate and transmits the packet train 10 at this fixed data transmission rate, the packet train 10 received at the monitor host 15 would become incomplete or even lost due to an insufficient available bandwidth in the wireless/wired network 13, causing major degradation in the quality of the image received at the monitor host 15.

Therefore, for all transmitting ends in the end-to-end network system transmitting packets at the fixed data transmission rate, the cross traffic thereof would result in incompletely received packets or even lost packets. On the other hand, when the cross traffic is not heavy, transmitting packets at a fixed data transmission rate will waste the available bandwidth in the network system.

In view of this, it is important to provide a solution that may continuously detect the available bandwidth in a network system with time-varying conditions while appropriately adjusting the data transmission rate used at the transmitting end accordingly.

### SUMMARY OF THE INVENTION

One objective of this invention is to provide a network system, an adjusting method of a data transmission rate in the network system and a computer program product thereof During an initial phase of the network system's operation, this invention detects whether the network system is in a heavy cross traffic status by the time information contained in packets. This invention decreases the data transmission rate thereof rapidly when the network system is in the heavy cross traffic status.

To achieve the above objective, the network system comprises a transmitting apparatus and a receiving apparatus. When the network system starts its operation, the transmitting apparatus transmits a packet train comprising a plurality of packets at a first transmission rate, wherein the packet train includes a first packet and a second packet. The receiving apparatus is configured to receive the packet train at a receiving rate, and calculates a delay factor according to a transmission interval of the first packet and a transmission interval of the second packet. The receiving apparatus is also configured to compare the delay factor with a predetermined value stored in the receiving apparatus. When the delay factor is greater than the predetermined value, the receiving apparatus transmits an adjustment signal, so that the transmitting apparatus adjusts the first transmission rate as a second transmission rate in response to the adjustment signal, wherein the second transmission rate is the same as the receiving rate.

Similarly, when the network system starts its operation, the adjusting method of a data transmission rate in the network system comprises the following steps: transmitting a packet train comprising a plurality of packets at a first transmission rate, wherein the packet train includes a first packet and a second packet; receiving the packet train at a receiving rate; calculating a delay factor according to a transmission interval of the first packet and a transmission interval of the second packet; comparing the delay factor with a predetermined value; transmitting an adjustment signal when the delay factor is greater than the predetermined value; and adjusting the first transmission rate as a second transmission rate in response to the adjustment signal, wherein the second transmission rate is the same as the receiving rate.

Furthermore, this invention provides a computer program product for the network system. When the computer program product is loaded into the network system via a computer to execute a plurality of program instructions embodied thereon, the adjusting method of a data transmission rate described above can be accomplished when the network system starts its operation.

Another objective of this invention is also to provide a network system, an adjusting method of a data transmission rate in the network system and a computer program product thereof During the continuous operation of the network system, this invention detects whether the network system is in a heavy cross traffic status in various manners. This invention decreases the data transmission rate thereof rapidly when the network system is in the heavy cross traffic status. Otherwise, this invention increases the data transmission rate thereof correspondingly if the network system is not in the heavy cross traffic status.

To achieve the above objective, the network system comprises a transmitting apparatus and a receiving apparatus. During the continuous operation of the network system, the transmitting apparatus transmits a packet train comprising a plurality of packets at a first transmission rate, wherein the packet train includes a first packet and a second packet The receiving apparatus records information of the receiving rate upon receiving the packet train at a receiving rate. Meanwhile, the receiving apparatus calculates information of the first transmission rate and a packet lost rate of the packet train. Finally, the receiving apparatus transmits an adjustment signal to the transmitting apparatus at least partially based on the information of the first transmission rate, the information of the receiving rate and the packet lost rate of the packet train. The transmitting apparatus adjusts the first transmission rate as a second transmission rate in response to the adjustment signal, wherein the second transmission rate and the first transmission rate are different.

Similarly, during the continuous operation of the network system, the adjusting method of a data transmission rate in the network system comprises the following steps: transmitting a packet train comprising a plurality of packets at a first transmission rate, wherein the packet train includes a first packet and a second packet; receiving the packet train at a receiving rate; recording information of the receiving rate; calculating information of the first transmission rate; calculating a packet lost rate of the packet train; transmitting an adjustment signal at least partially based on the information of the first transmission rate, the information of the receiving rate and the packet lost rate of the packet train; and adjusting the first transmission rate as a second transmission rate in response to the adjustment signal, wherein the second transmission rate and the first transmission rate are different.

Furthermore, this invention provides a computer program product for the network system. When the computer program product is loaded into the network system via a computer to execute a plurality of program instructions embodied thereon, the adjusting method of a data transmission rate described above can be accomplished during the continuous operation of the network system.

In summary, according to the network system, the adjusting method of a data transmission rate and the computer program product thereof disclosed in this invention, even within the limited available bandwidth resources, a heavy cross traffic status can be detected by calculating the associated parameters according to the packet train received at the receiving end. In this way, the available bandwidth conditions of the network system can be known to adjust the data transmission rate of the network system appropriately.

The detailed technology and preferred embodiments implemented for the subject invention are described in the following paragraphs accompanying the appended drawings for people skilled in this table to well appreciate the features of the claimed invention.

### BRIEF DESCRIPTION OF THE DRAWINGS

FIG. 1 is a schematic view of a network monitoring system of the prior art;

FIG. 2 is a schematic view of a first embodiment of this invention;

FIG. 3A is a schematic view of a packet structure in a network system of this invention;

FIG. 3B is a schematic view of another packet structure in the network system of this invention;

FIG. 4 is a flowchart of an adjusting method of a data transmission rate in an initial phase;

FIG. 5 is a schematic view of a second embodiment of this invention; and

FIGS. 6A to 6D illustrate a flowchart of an adjusting method of a data transmission rate during a transmission phase.

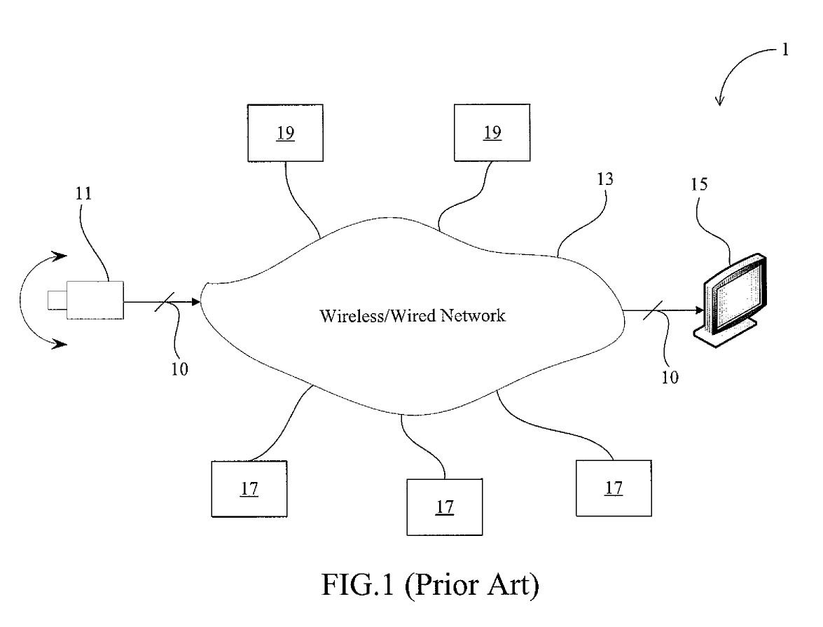

### DESCRIPTION OF THE PREFERRED EMBODIMENT

This invention provides a network system, an adjusting method of a data transmission rate in the network system and a computer program product thereof. The following embodiments are only intended to illustrate the concepts and content of this invention, rather than to limit this invention to any specific environment, applications or particular implementations. It should be appreciated that in the following embodiments and the attached drawings, the elements not related directly to this invention are omitted from depiction.

The network system of this invention and the adjusting method of a data transmission rate thereof are implemented in two phases, i.e., adjustment of the data transmission rate in an initial phase and a transmission phase. Hereinafter, the network system and the method for adjusting a data transmission rate in the initial phase will be described in a first embodiment, while the network system and the method for adjusting the data transmission rate during a period from the initial phase to the transmission phase will be described in a second embodiment.

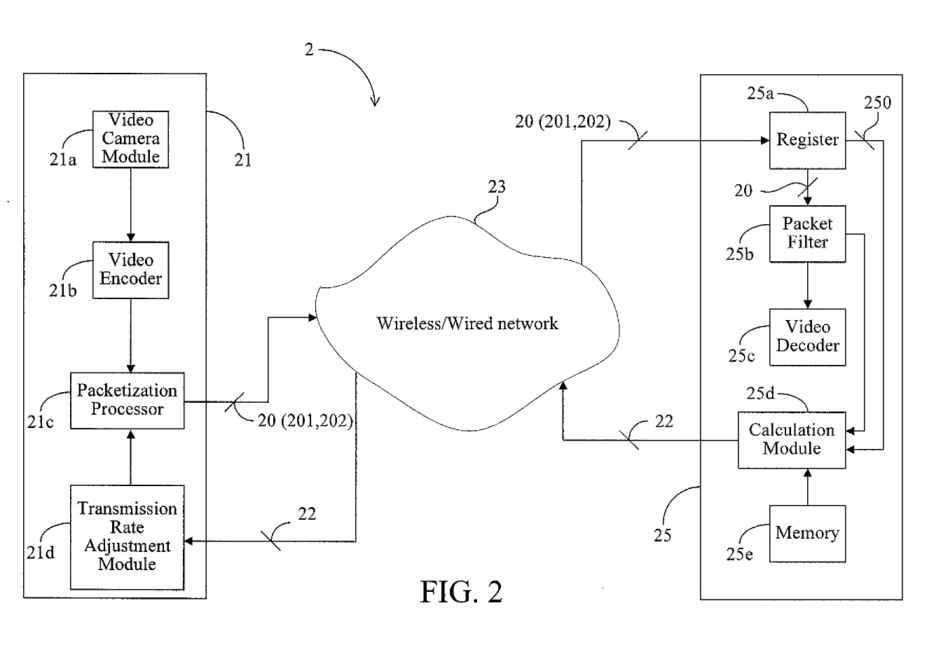

FIG. 2 depicts an end-to-end network system in the first embodiment and the second embodiment, e.g., a network monitoring system 2 comprising a transmitting apparatus 21, a wireless/wired network 23 and a receiving apparatus 25. The wireless/wired network 23 may be a wireless network conforming to the WiFi (IEEE 802.11), or WiMax (IEEE 802.16) wireless communication standards, or a wired network of any other type. Since the network monitoring system 2 is an end-to-end network system capable of multimedia streaming transmission, it adopts the Real-Time Transport Protocol (RTP) and the Real-Time Transport Control Protocol (RTCP) for packet transmission between the transmitting apparatus 21 and the receiving apparatus 25.

The RTP is able to add time information in packets and synchronize the multimedia streaming transmission, while the RTCP is able to add information, such as the number of transmitted packets, in packets. With the information, the data transmission rate at which the network monitoring system 2 transmits the packets can be appropriately adjusted.

In this embodiment, the transmitting apparatus 21, which is essentially a webcam, comprises a video camera 21a, a video encoder 21b, a packetization processor 21c and a transmission rate adjustment module 21d. In other examples, the transmitting apparatus 21 may also be a personal computer (PC), while the video camera module 21a may be various commercially available webcams. The receiving apparatus 25 may be a common PC or a server. The receiving apparatus 25 comprises a register 25a, a packet filter 25b, a video decoder 25c, a calculation module 25d and a memory 25e. The memory 25e is configured to store a first predetermined value, a second predetermined value and a third predetermined value (not shown). Here, the first predetermined value is associated with the number of transmitted packets and the number of received packets, while the second predetermined value is associated with the transmission interval of the packets, and the third predetermined value is associated with the transmitted/received rate of packets.

Hereinafter, the network system and a flow chart of the adjusting method of a data transmission rate thereof during an initial phase will be detailed in the first embodiment. During the initial phase, e.g., after the transmitting apparatus 21 is initially connected to the wireless/wired network 23, the packetization processor 21c of the transmitting apparatus 21 transmits a packet train 20 to the wireless/wired network 23 at the first transmission rate (e.g., 1.5 Mb/sec). The packet train 20 comprises a plurality of packets. In the first embodiment, the packet train 20 comprises a first packet 201 and a second packet 202, wherein the first packet 201 and the second packet 202 are both substantially incorporating video data payload

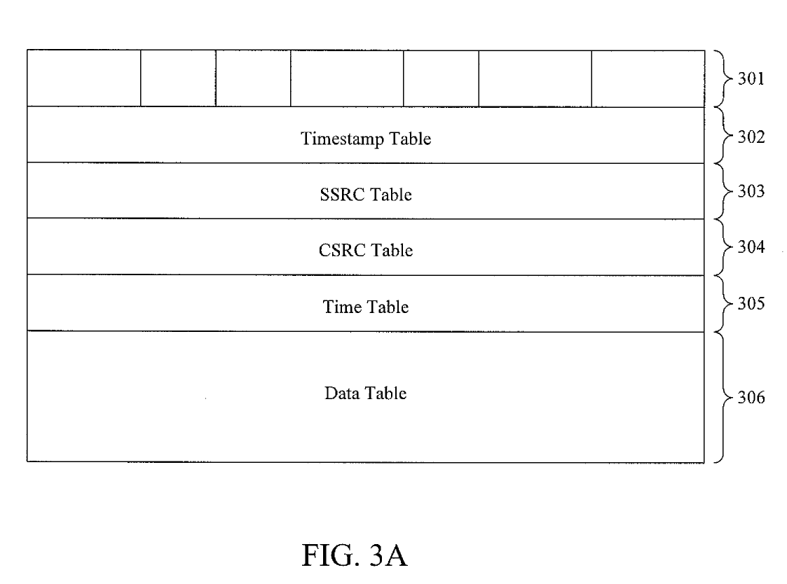

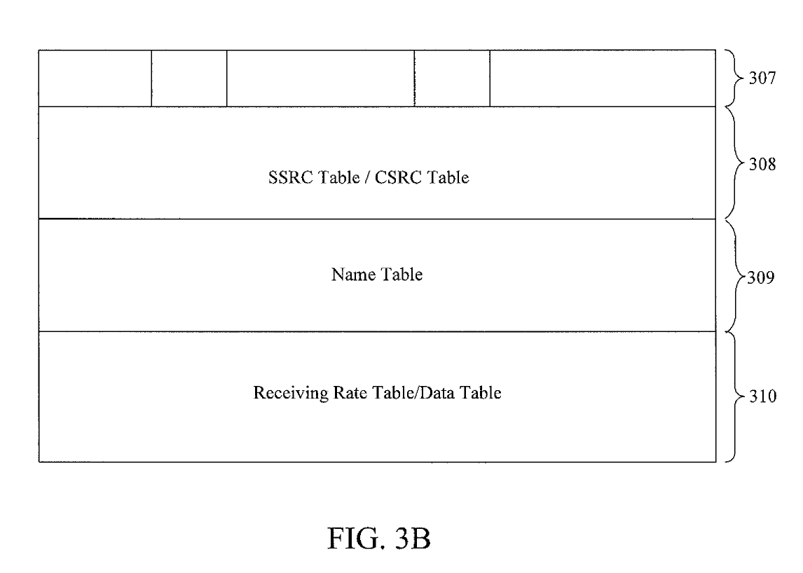

FIG. 3A depicts a schematic view of a packet structure of the first packet 201 and the second packet 202. Each of the packets has an information label table 301 comprising of a plurality of sub-tables, a timestamp table 302, a synchronization source (SSRC) table 303, a contributing source (CSRC) table 304, a time table 305 and a data table 306. When the packetization processor 21c of the transmitting apparatus 21 initially transmits the first packet 201, a first transmission time of the first packet 201 is recorded in the time table 305 of the first packet 201. When the packetization processor 21c of the transmitting apparatus 21 subsequently transmits the second packet 202, a second transmission time of the second packet 202 is recorded in the time table 305 of the second packet 202.

Upon receiving the packet train 20 at a receiving rate (e.g., 1.0 Mb/sec), the receiving apparatus 25 first stores information 250 of the receiving rate in the register 25a, and records a first receiving time in which the first packet 201 is received and a second receiving time in which the second packet 202 is received in the register 25a. Subsequently, the packet filter 25b retrieves the first transmission time from the time table 305 of the first packet 201 and the second transmission time from the time table 305 of the second packet 202.

The calculation module 25d then receives (1) the information 250 of the receiving rate, (2) both the first receiving time in which the first packet 201 is received and the second receiving time in which the second packet 202 is received that are stored in the register 25a, and (3) both the first transmission time of the first packet 201 and the second transmission time of the second packet 202 that are retrieved by the packet filter 25b.

The calculation module 25d calculates a difference between the first transmission time and the first receiving time of the first packet 201 to represent a transmission interval of the first packet 201. The calculation module 25d also calculates a difference between the second transmission time and the second receiving time of the second packet 202 to represent a transmission interval of the second packet 202. It should be noted that during the transmission, the first packet 201 and the second packet 202 of the packet train 20 are routed through the wireless/wired network 23 which demonstrates time-varying conditions (i.e., whether in a heavy cross traffic status), so the transmission interval of the first packet 201 and that of the second packet 202 may not be the same.

Then, the calculation module 25d calculates a delay factor of the packet train 20 according to the respective transmission intervals of the first packet 201 and the second packet 202 as follows:

$$S = \frac{{\sum }_{k = 2}^{N} {\sum }_{l = 1}^{k - 1} I ( {D}_{k} > {D}_{l} )}{\frac{N ( N - 1 )}{2}} \qquad \{ \begin{matrix}I ( {D}_{k} > {D}_{l} ) = 1 if {D}_{k} > {D}_{l} \\ I ( {D}_{k} > {D}_{l} ) = 0 , otherwise .\end{matrix}$$

S represents the delay factor of the packet train 20; N represents the number of packets in the packet train 20. In the present example, the packet train 20 has the first packet 201 and the second packet 202, i.e. N=2. D1 represents the transmission interval of the first packet 201, while D2 represents the transmission interval of the second packet 202.

The calculation module 25d will compare the transmission interval D1 of the first packet 201 with the transmission interval D2 of the second packet 202. If the transmission interval D1 of the first packet 201 is greater than or equal to the transmission interval D2 of the second packet 202, this means that the wireless/wired network 23 is not in a heavy cross traffic status, and the result of I (D2>D1) will be 0. Then, through calculations, the delay factor S of the packet train 20 is equal to 0. In contrast, if the transmission interval D1 of the first packet 201 is smaller than the transmission interval D2 of the second packet 202, this means that the wireless/wired network 23 is now in a heavy cross traffic status, and the result of I (D2>D1) will be 1. Then, through calculations, the delay factor S of the packet train 20 is equal to 1.

Next, the smaller value between the transmission interval D1 of the first packet 201 and the transmission interval D2 of the second packet 202 is defined as the smallest transmission interval value in the packet train 20, and will be stored in the register 25a. Then, a predetermined threshold value is added to and subtracted from the smallest transmission interval value stored in the register 25a to form an upper limit and a lower limit of a predetermined range respectively. For example, if the transmission interval D1 of the first packet 201 is 6 seconds (secs), while the transmission interval D2 of the second packet 202 is 5 secs, the smallest transmission interval value is 5. If the predetermined threshold value is set to be 0.5, then the upper limit and the lower limit of the predetermined range will be 5.5 and 4.5 respectively. Finally, this predetermined range is stored in the memory 25e.

Once the delay factor S of the packet train 20 is calculated, the calculation module 25d further compares the delay factor S with a second predetermined value stored in the memory 25e. The second predetermined value is set to range from 0.55 to 0.75, and in the first embodiment, is set to be 0.7. It should be noted that the range of the second predetermined value of above description is for illustration purpose, not to limit this invention. Briefly speaking, a larger delay factor S means a heavier cross traffic status, hence a smaller available bandwidth in the wireless/wired network 23. If the delay factor S is greater than the second predetermined value, this means that the wireless/wired network 23 is in an over crowed status, in which case the wireless/wired network 23 will fail to continue the transmission of other packet trains at the first transmission rate (i.e., 1.5 Mb/sec) originally determined by the transmitting apparatus 21.

At this moment, the receiving apparatus 25 transmits an adjustment signal 22 comprising the information 250 of the receiving rate (i.e., 1.0 Mb/sec) to the transmitting apparatus 21. The adjustment signal is essentially an application defined RTCP packet (APP). FIG. 3B illustrates a schematic view of a packet structure of the adjustment signal 22. The adjustment signal 22 comprises an information label table 307, a synchronization source table 308, a name table 309 and a receiving rate table/data table 310. The information 250 of the receiving rate resides in the receiving rate table/data table 310. In other examples, the adjustment signal 22 may also be an RTCP packet. In response to the adjustment signal 22, the transmission rate adjustment module 21d of the transmitting apparatus 21 adjusts the first transmission rate (i.e., 1.5 Mb/sec) originally set by the packetization processor 21c of the receiving apparatus 25 as a second transmission rate that is equal to the receiving rate (i.e., 1.0 Mb/sec). In this way, the network monitoring system 2 can adjust the data transmission rate rapidly during the initial phase by detecting the cross traffic condition of the wireless/wired network 23 to decrease the probability of causing incomplete or lost packet trains in the network monitoring system 2.

In other embodiments, considering of the video quality gap between two different transmission rates, the first transmission rate will not be adjusted to be the receiving rate (i.e., 1.0 Mb/sec) for once. For example, the first transmission rate can be adjusted as 1.2 Mb/sec and 1.0 Mb/sec in order.

In the above manner and through the above operations, the network monitoring system 2 continues to adjust the data transmission rate at which the packetization processor 21c of the transmitting apparatus 21 transmits packets during the initial phase, until the delay factor S is smaller than the second predetermined value; that is, the transmitting apparatus 21 enters the transmission phase. It should be noted that the packet train 20 actually comprises ten to thirty packets. Although the first embodiment has only two packets (i.e., the first packet 201 and the second packet 202), the number of packets in the packet train 20 is not limited in this invention. Those of ordinary skill in the art may devise themselves the number of packets of the packet train 20 based on the above description and calculate the delay factor S according to the above formula, and this will not be further described herein.

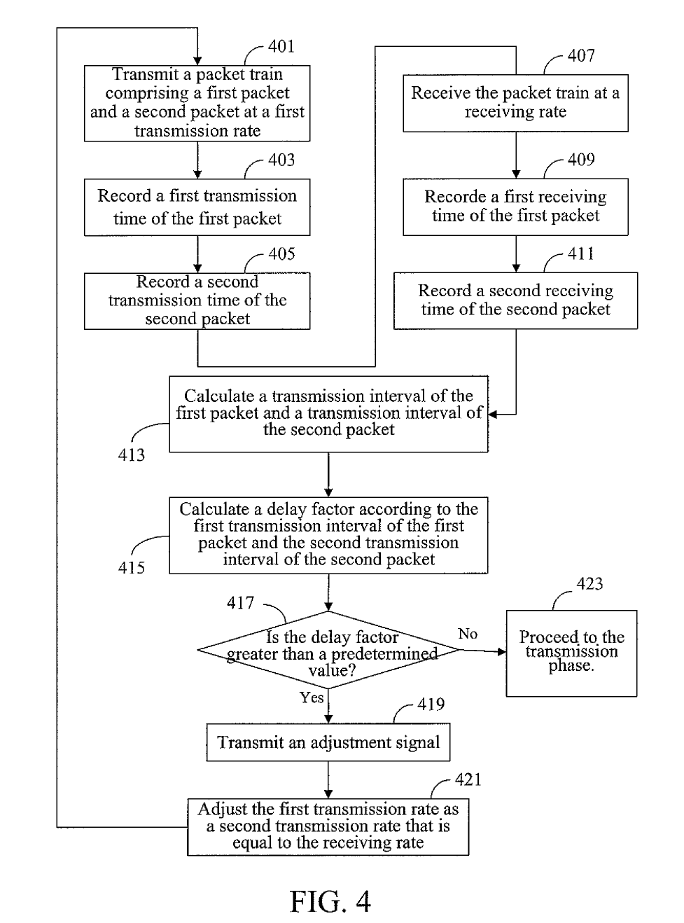

FIG. 4 depicts an adjusting method of a data transmission rate during the initial phase, which is adapted for the network monitoring system 2 described in the first embodiment. More specifically, the adjustment method for the first embodiment may be executed by a computer program product. The computer program product is loaded into the network monitoring system 2 via a computer to execute a plurality of program instructions embodied thereon, so that the adjustment method for the first embodiment can be accomplished. This computer program product may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

The adjusting method of a data transmission rate during the initial phase comprises the following steps. Initially in Step 401, a packet train comprising a plurality of packets is transmitted at a first transmission rate, wherein the packet train comprises a first packet and a second packet, and the first packet and the second packet are both substantially incorporating audio/video data payload. Then, a first transmission time of the first packet is recorded in Step 403. A second transmission time of the second packet is recorded in Step 405. Next in Step 407, the packet train is received at a receiving rate. In Step 409, a first receiving time of the first packet is recorded after the first packet is received. In Step 411, a second receiving time of the second packet is recorded after the second packet is received. Thereafter, in Step 413, a transmission interval of the first packet is calculated according to the first transmission time and the first receiving time of the first packet. Also via Step 413, a transmission interval of the second packet is calculated according to the second transmission time and the second receiving time of the second packet.

In Step 415, a delay factor is calculated according to the first transmission interval of the first packet and the second transmission interval of the second packet. In Step 417, the delay factor is compared with a predetermined value (e.g., the second predetermined value described in the first embodiment). It is also determined whether the delay factor is greater than the predetermined value via Step 417. If the answer is yes in Step 417, an adjustment signal is transmitted in Step 419, and the first transmission rate is adjusted into a second transmission rate that is equal to the receiving rate in Step 421. However, the first transmission rate can also be adjusted to be the receiving rate for several times to mitigate the video quality gap between two different transmission rates.

Then, the process returns to Step 401 where another packet train comprising a plurality of packets is transmitted at the second transmission rate. Otherwise, if it is determined in Step 417 that the delay factor is no greater than the predetermined value, the process proceeds to the transmission phase in Step 423.

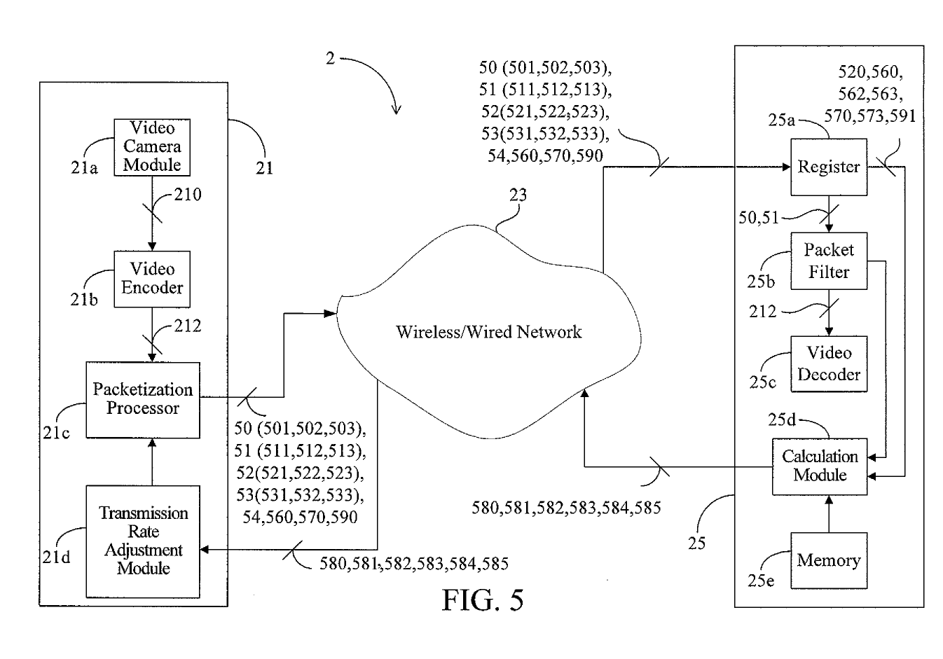

Hereinafter, the network system and a flow chart of the adjusting method of a data transmission rate thereof during a period from the initial phase to the transmission phase will be detailed in the second embodiment with reference to the hardware structure as shown in FIGS. 2 to 5. In the second embodiment, portions identical to those of the first embodiment will not be described again.

Similarly, during the initial phase, the packetization processor 21c of the transmitting apparatus 21 transmits a first packet train 50 to the wireless/wired network 23 at a first transmission rate, e.g., 2.0 Mb/sec. The first packet train 50 comprises a plurality of packets, and in the second embodiment, comprises a first packet 501, a second packet 502 and a third packet 503, wherein the first packet 501, the second packet 502 and the third packet 503 are substantially incorporating video data payload. It should be noted that the number of packets in the first packet train 50 is only provided to illustrate the second embodiment rather than to limit this invention. A packet structure of each of the first packet 501, the second packet 502 and the third packet 503 is as depicted in FIG. 3A and as described in the first embodiment, and thus will not be described again herein.

After having transmitted the first packet 501, the second packet 502 and the third packet 503 respectively, the packetization processor 21c of the transmitting apparatus 21 records a first transmission time of the first packet 501, a second transmission time of the second packet 502 and a third transmission time of the third packet 503 in the respective time tables 305 of the first packet 501, the second packet 502 and the third packet 503.

When receiving the first packet train 50 at a receiving rate (e.g., 1.5 Mb/sec), the receiving apparatus 25 first stores information 520 of the receiving rate in the register 25a, and records in the register 25a a first receiving time at which the first packet 501 is received, a second receiving time at which the second packet 502 is received and a third receiving time at which the third packet 503 is received. Subsequently, the packet filter 25b retrieves and records the first transmission time of first packet 501, the second transmission time of the second packet 502 and the third transmission time of the third packet 503.

The calculation module 25d then receives (1) the information 520 of the receiving rate, (2) the first receiving time at which the first packet 501 is received, the second receiving time at which the second packet 502 is received and the third receiving time at which the third packet 503 is received that are stored in the register 25a, and (3) the first transmission time of the first packet 501, the second transmission time of the second packet 502 and the third transmission time of the third packet 503 that are retrieved by the packet filter 25b.

The calculation module 25d calculates a difference between the first transmission time and the first receiving time of the first packet 501 to represent a transmission interval of the first packet 501. The calculation module 25d also calculates a difference between the second transmission time and the second receiving time of the second packet 502 to represent a transmission interval of the second packet 502, and further calculates a difference between the third transmission time and the third receiving time of the third packet 503 to represent a transmission interval of the third packet 503.

Then, the calculation module 25d calculates a first delay factor S1 of the first packet train 50 according to the respective transmission intervals of the first packet 501, the second packet 502 and the packet 503. Here, the first delay factor S1 can be calculated by the computation method described in the first embodiment, and thus will not be described again herein.

After having derived the transmission interval D1 of the first packet 501, the transmission interval D2 of the second packet 502 and the transmission interval D3 of the third packet 503, the calculation module 25d compares them with each other. If the transmission interval D1 of the first packet 501 is smaller than both the transmission interval D2 of the second packet 502 and the transmission interval D3 of the third packet 503, and the transmission interval D2 of the second packet 502 is smaller than the transmission interval D3 of the third packet 503, this means that the wireless/wired network 23 is now in a heavy cross traffic status, and the results of I(D2>D1), I(D3>D1) and I(D3>D2) will all be 1 respectively.

Next, the smallest value among the transmission interval D1, the transmission interval D2 and the transmission interval D3 is defined as the smallest transmission interval value of the first packet train 50, and stored in the register 25a. Then, a predetermined threshold value is added to and subtracted from the smallest transmission interval value stored in the register 25a to form an upper limit and a lower limit of a predetermined range respectively. For example, if the transmission interval D1 of the first packet 501 is 5 secs, the transmission interval D2 of the second packet 502 is 6 secs, and the transmission interval D3 of the third packet 503 is 8 secs, the smallest transmission interval value is set to be 5. If the predetermined threshold value is set to be 0.5, then the upper limit and the lower limit of the predetermined range will be 5.5 and 4.5 respectively. Finally, this predetermined range is stored in the memory 25e.

Further, the calculation module 25d compares the first delay factor S1 (i.e., 1) with a second predetermined value stored in the memory 25e. As with the second predetermined value of the first embodiment, the second predetermined value of the second embodiment is set to be 0.7. Because the first delay factor S1 is still greater than the second predetermined value, it is determined that the wireless/wired network 23 still remains in the heavy cross traffic status.

At this moment, the receiving apparatus 25 transmits a first adjustment signal 580 comprising the information 520 of the receiving rate (i.e., 1.5 Mb/sec) to the transmitting apparatus 21. The first adjustment signal 580 is essentially a physically defined RTCP packet. In response to the adjustment signal 580, the transmission rate adjustment module 21d of the transmitting apparatus 21 adjusts the first transmission rate (i.e., 2.0 Mb/sec) originally set by the packetization processor 21c of the receiving apparatus 25 into a second transmission rate that is equal to the receiving rate (i.e., 1.5 Mb/sec).

Because the first delay factor S1 (i.e., 1) is greater than the second predetermined value (i.e., 0.7), an appropriate data transmission rate still has to be found for transmission between the transmitting apparatus 21 and the receiving apparatus 25, i.e., the initial stage has not ended yet so far. More specifically, the transmitting apparatus 21 will transmit a second packet train 51 comprising a plurality of packets. Here, the second packet train 51 comprises a first packet 511, a second packet 512 and a third packet 513, wherein the first packet 511, the second packet 512 and the third packet 513 are substantially incorporating video data payload. Similarly, with the computation method described in the first embodiment, a second delay factor S2 can be calculated according to the transmission interval D1 of the first packet 511, the transmission interval D2 of the second packet 512 and the transmission interval D3 of the third packet 513.

If the transmission interval D1 of the first packet 511 is smaller than both the transmission interval D2 of the second packet 512 and the transmission interval D3 of the third packet 513, and the transmission interval D2 of the second packet 512 is greater than the transmission interval D3 of the third packet 513, this means that the results of I(D2>D1) and I(D3>D1) will be 1 while the result of (D3>D2) will be 0. Then, through calculation by the calculation module 25d according to the formula for calculating the delay factor, a second delay factor S2 of the second packet train 51 is calculated to be approximately 0.67. Because the second delay factor S 2 (i.e., 0.67) is smaller than the second predetermined value (i.e., 0.7), this means that the transmitting apparatus 21 is moving form the initial phase to the transmission phase.

Meanwhile, if the smallest value among the transmission interval D1 of the first packet 511, the transmission interval D2 of the second packet 512 and the transmission interval D3 of the third packet 513 in the second packet train 51 is smaller than the smallest transmission interval value previously stored in the register 25a, the smallest transmission interval value stored in the register 25a will be updated into the smallest value among the transmission interval D1 of the first packet 511, the transmission interval D2 of the second packet 512 and the transmission interval D3 of the third packet 513. Therefore, the predetermined range will be re-calculated. For instance, if the transmission interval D1 of the first packet 511 is 4 secs, the transmission interval D2 of the second packet 512 is 6 secs, and the transmission interval D3 of the third packet 513 is 5 secs, the calculation module 25d will determine, through a comparison, that the transmission interval D1 of the first packet 511 is smaller than the smallest transmission interval value (i.e., 5) previously stored in the register 25a. Accordingly, the smallest transmission interval value is updated to be 4. If the predetermined threshold value is set to be 0.5, then the upper limit and the lower limit of the predetermined range will be updated to be 4.5 and 3.5 respectively. Finally, this predetermined range is stored in the memory 25e.

During the transmission phase, the video encoder 21b of the transmitting apparatus 21 may continue to compress video data 210 retrieved by the video camera module 21a according to the second transmission rate adjusted during the initial phase, and then the packet trains comprising the compressed video data 212 are transmitted. During the transmission phase, the transmitting apparatus 21 enters a probing period at a regular interval to detect whether the conditions in the wireless/wired network 23 allows an increase in the transmission rate. In this embodiment, this period is set to be 10 sec. However, those of ordinary skill in the art may set the duration of the probing period by themselves depending on practical needs, e.g., 20 secs or 30 secs. For the time other than the probing period, the transmitting apparatus 21 is in non-probing periods and continues to transmit data (e.g., a fifth packet train 54) comprising the compressed video data 212.

The packetization processor 21c of the transmitting apparatus 21 transmits a third packet train 52 comprising time information to the wireless/wired network 23 at the second transmission rate (i.e., 1.5 Mb/sec) adjusted during the initial phase. The third packet train 52 comprises a plurality of packets. Here, the third packet train 52 comprises a first packet 521, a second packet 522 and a third packet 523, wherein the first packet 521, the second packet 522 and the third packet 523 are substantially incorporating video data payload. Meanwhile, the packetization processor 21c of the transmitting apparatus 21 also transmits information 560 of the number of packets transmitted to the wireless/wired network 23.

Upon receiving the third packet train 52 at a receiving rate (e.g., 1.5 Mb/sec), the receiving apparatus 25 records a first receiving time at which the first packet 521 is received, a second receiving time at which the second packet 522 is received, a third receiving time at which the third packet 523 is received, and the information 560 of the number of packets transmitted in the register 25a. The information 563 of the number of packets received from the third packet train 52 is also stored in the register 25a. Subsequently, the packet filter 25b retrieves the first transmission time from the time table 305 of the first packet 521, the second transmission time from the time table 305 of the second packet 522 and the third transmission time from the time table 305 of the third packet 523.

The calculation module 25d then receives (1) the information 560 of the number of transmitted packets, the information 563 of the number of received packets, (2) the first receiving time at which the first packet 521 is received, the second receiving time at which the second packet 522 is received and the third receiving time at which the third packet 523 is received that are stored in the register 25a, and (3) the first transmission time of the first packet 521, the second transmission time of the second packet 522 and the third transmission time of the third packet 523 that are retrieved by the packet filter 25b.

The calculation module 25d calculates a difference between the first transmission time and the first receiving time of the first packet 521 to represent a transmission interval (e.g., 7 sec) of the first packet 521, and calculates a difference between the second transmission time and the second receiving time of the second packet 522 to represent a transmission interval (e.g., 5.5 sec) of the second packet 522. The calculation module 25d also calculates a difference between the third transmission time and the third receiving time of the third packet 523 to represent a transmission interval (e.g., 3.8 sec) of the third packet 523. It should be noted that during transmission to the receiving apparatus 25, the first packet 521, the second packet 522 and the third packet 523 of the packet train 52 are routed through the wireless/wired network 23 which demonstrates time-varying conditions (i.e., whether in a heavy cross traffic status), so the transmission intervals of the first packet 521, the second packet 522 and the third packet 523 are not all the same.

The calculation module 25d calculates a packet lost rate of the third packet train 52 according to the information 560 of the number of transmitted packets and the information 563 of the number of received packets.

The calculation module 25d then compares the packet lost rate of the third packet train 52 with a first predetermined value stored in the memory 25e. The first predetermined value is set to range from 0% to 15%. It should be noted that the range of the first predetermined value of above description should depend on different application, and is not limited by above description. In the second embodiment, the first predetermined value is set at 3%.

In the third packet train 52, if one of the transmission intervals of the first packet 521, second packet 522 and third packet 523 falls within the predetermined range (i.e., 4.5-3.5), and the packet lost rate of the third packet train 52 is smaller than the first predetermined value (i.e., 3%), this means that the wireless/wired network 23 is not in a heavy cross traffic status and there still exist an available bandwidth.

Then, the receiving apparatus 25 transmits a second adjustment signal 581 to the transmitting apparatus 21. Upon receiving the second adjustment signal 581, the transmission rate adjustment module 21d of the transmitting apparatus 21 increases the transmission rate from the original second transmission rate (i.e., 1.5 Mb/sec) to a third transmission rate (i.e., 2.0 Mb/sec).

Subsequently, the calculation module 25d further compares the transmission interval (i.e., 7 secs) of the first packet 521, the transmission interval (i.e., 5.5 secs) of the second packet 522 and the transmission interval (i.e., 3.8 secs) of the third packet 523 with the smallest transmission interval value (i.e., 4) stored in the register 25a. Because the transmission interval (i.e., 3.8 secs) of the third packet 523 is smaller than the smallest transmission interval value (i.e., 4), the smallest transmission interval value is updated into the transmission interval value of the third packet 523. Also, as the smallest delay value is updated, the upper and the lower limits of the predetermined range will be updated accordingly.

The packetization processor 21c of the transmitting apparatus 21 transmits a fourth packet train 53 comprising time information to the wireless/wired network 23 at the third transmission rate (i.e., 2.0 Mb/sec). Meanwhile, the packetization processor 21c of the transmitting apparatus 21 also transmits information 570 of the number of packets transmitted to the wireless/wired network 23 of the fourth packet train 53. The fourth packet train 53 comprises a plurality of packets. In the second embodiment the fourth packet train 53 comprises a first packet 531, a second packet 532 and a third packet 533, wherein the first packet 531, the second packet 532 and the third packet 533 are substantially incorporating video data payload.

A packet structure of each of the first packet 531, the second packet 532 and the third packet 533 is as depicted in FIG. 3. When the packetization processor 21c of the transmitting apparatus 21 firstly transmits the first packet 531, it records a first transmission time of the first packet 531 in the time table 305 of the first packet 531. Likewise, when the packetization processor 21c of the transmitting apparatus 21 subsequently transmits the second packet 532 and the third packet 533, it records a second transmission time of the second packet 532 and a third transmission time of the third packet 533 in the respective time tables 305 of the second packet 532 and the third packet 533.

Upon receiving the fourth packet train 53 at a receiving rate, the receiving apparatus 25 records a first receiving time in which the first packet 531 is received, a second receiving time in which the second packet 532 is received, a third receiving time in which the third packet 533 is received and the information 570 of the number of transmitted packets, and also stores in the register 25a information 573 of the number of packets received from the fourth packet train 53. Subsequently, the packet filter 25b retrieves the first transmission time from the time table 305 of the first packet 531, the second transmission time from the time table 305 of the second packet 532 and the third transmission time from the time table 305 of the third packet 533.

The calculation module 25d then receives (1) the information 570 of the number of transmitted packets, the information 573 of the number of received packets, (2) the first receiving time in which the first packet 531 is received, the second receiving time in which the second packet 532 is received and the third receiving time in which the third packet 533 is received that are stored in the register 25a, as well as (3) the first transmission time of the first packet 531, the second transmission time of the second packet 532 and the third transmission time of the third packet 533 that are retrieved by the packet filter 25b.

Subsequently, the calculation module 25d calculates the information of the third transmission rate according to the transmission times recorded in respective time tables 305. Specifically, in reference to FIG. 3A, various factors (e.g., collisions or routes) during the transmission of the packets via the network may result in different transmission times, so the transmission time of each packet in the fourth packet train 53 is recorded in the time table 305 of the corresponding packet. Hence, from the respective time tables 305 of the fourth packet train 53 and the information 570 of the number of transmitted packets, the information of the third transmission rate for the fourth packet train 53 can be derived.

The calculation module 25d calculates (1) a transmission interval of the first packet 531 according to the first transmission time and the first receiving time of the first packet 531, (2) a transmission interval of the second packet 532 according to the second transmission time and the second receiving time of the second packet 532, and (3) a transmission interval of the third packet 533 according to the third transmission time and the third receiving time of the third packet 533.

Then, according to the transmission intervals of the first packet 531, the second packet 532 and the third packet 533, the calculation module 25d calculates a fourth delay factor S4 of the fourth packet train 53 by using the computation method described in the first embodiment. Once the fourth delay factor S4 of the fourth packet train 53 is obtained, the calculation module 25d further compares the fourth delay factor S4 with the second predetermined value (i.e., 0.7) stored in the memory 25e.

If the fourth delay factor S4 is not greater than the second predetermined value (i.e., 0.7), this means that the wireless/wired network 23 is not in a heavy cross traffic status and there is an available bandwidth. Then, the receiving apparatus 25 transmits a third adjustment signal 582 to the transmitting apparatus 21. Upon receiving the third adjustment signal 582, the transmission rate adjustment module 21d of the transmitting apparatus 21 utilizes a fourth transmission rate to transmit other data. Here, the fourth transmission rate is substantially the third transmission rate (i.e., 2.0 Mb/sec).

On the other hand, if the fourth delay factor S4 is greater than the second predetermined value (i.e., 0.7), this means that transmitting other packet trains at the third transmission rate (i.e., 2.0 Mb/sec) would cause heavy cross traffic in the wireless/wired network 23. In this case, the receiving apparatus 25 transmits a fourth adjustment signal 583 to the transmitting apparatus 21. Upon receiving the fourth adjustment signal 583, the transmission rate adjustment module 21d of the transmitting apparatus 21 adjusts the transmission rate from the third transmission rate (i.e., 2.0 Mb/sec) to a fourth transmission rate for transmitting other data. Here, the fourth transmission rate is substantially the second transmission rate (i.e., 1.5 Mb/sec), which is lower than the third transmission rate (i.e., 2.0 MBb/sec).

In the above description, the periodical transmission of packet trains within the probing period has been described. The transmission of packet trains within the non-probing period will be described as follows.

The video encoder 21b of the transmitting apparatus 21 can continue to compress the video data 210 retrieved by the video camera module 21a according to the fourth data transmission rate adjusted as described above, and transmit the fifth packet train 54 incorporating the compressed video data 212 with a plurality of packets. Meanwhile, the packetization processor 21c of the transmitting apparatus 21 also transmits information 590 of the number of transmitted packets of the fifth packet train 54 to the wireless/wired network 23.

Upon receiving the fifth packet train 54 at a receiving rate (e.g., 1.8 Mb/sec), the receiving apparatus 25 records the information 590 of the number of transmitted packets of the fifth packet train 54, the information 591 of the number of received packets of the fifth packet train 54 and information 562 of the receiving rate of the fifth packet train 54 in the register 25a. The receiving apparatus 25 calculates the information of the fourth transmission rate according to the transmission times recorded in the time tables 305. Specifically, in reference to FIG. 3A, various factors (e.g., collisions or routes) during the transmission of the packets via the network may result in different transmission times, so the transmission time of each packet of the fifth packet train 54 is recorded in the time table 305 of the corresponding packet. Hence, from the respective time tables 305 of the fifth packet train 54 and the information 590 of the number of transmitted packets, the information of the fourth transmission rate for the fifth packet train 54 can be derived.

The calculation module 25d then receives the information 590 of the number of transmitted packets and the information 591 of the number of received packets that are stored in the register 25a. Meanwhile, the packet filter 25b retrieves the compressed video data 212 and transmits it to the video decoder 25c to be decompressed, so that the receiving apparatus 25 can display the decompressed video data 210 on a display (not shown).

The calculation module 25d then calculates a packet lost rate of the fifth packet train 54 according to the information 590 of the number of transmitted packets and the information 591 of the number of received packets. Meanwhile, the calculation module 25d calculates a rate factor F according to the information 562 of the receiving rate and information of the fourth transmission rate for the fifth packet train 54 as follows:

$$F = \frac{{R}_{trx} - {R}_{rec}}{{R}_{trx}}$$

F represents the rate factor of the fifth packet train 54, Rₜᵣₓ represents information of the fourth transmission rate, and R_{rec} represents the information 562 of the receiving rate.

Finally, the calculation module 25d compares the packet lost rate of the fifth packet train 54 with the first predetermined value (3%) stored in the memory 25e, and compares the rate factor F of the fifth packet train 54 with the third predetermined value stored in the memory. Preferably, the third predetermined value is set to range from 0.1 to 0.2, and in the second embodiment, is set to be 0.15.

If the packet lost rate of the fifth packet train 54 is greater than the first predetermined value (i.e., 3%), or the rate factor F of the fifth packet train 54 is greater than the third predetermined value (i.e., 0.15), this means that the wireless/wired network 23 is in a heavy cross traffic status. In this case, the receiving apparatus 25 transmits a fifth adjustment signal 584 to the transmitting apparatus 21. Upon receiving the fifth adjustment signal 584, the transmission rate adjustment module 21d of the transmitting apparatus 21 adjusts the original fourth transmission rate to be lower, e.g., receiving rate of the fifth packet train 54.

In other examples, if the fifth packet train 54 is the movie data with a plurality of layers, a fewer number of layers of the fifth packet train 54 may be transmitted to reduce the bandwidth required for transmission. More specifically, as an example, the fifth packet train 54 has ten layers of movie data. The more layers are transmitted, the higher the definition of pictures will be obtained at the receiving apparatus when the movie is played. In other words, if the wireless/wired network 23 is in a heavy cross traffic status, the transmitting apparatus 21 may only transmit lower five of the ten layers of the movie data in response to the adjustment signal received. In other embodiments, the first transmission rate may be adjusted gradually. For example, the transmitting apparatus 21 may transmit following packet trains having seven, six and five of the ten layers in order. Otherwise, if the wireless/wired network 23 is not in a heavy cross traffic status, the transmitting apparatus 21 may increase the number of layers of the following packet trains to be transmitted.

In this way, by detecting the cross traffic condition in the wireless/wired network 23, the network monitoring system 2 can adjust the data transmission rate during the transmission phase to decrease the probability of causing incomplete or lost packet trains in the network monitoring system 2 and improve the operational efficacy of the wireless/wired network 23.

In the above manner and through the above operations, the network monitoring system 2 may continue to adjust the data transmission rate at which the packetization processor 21c of the transmitting apparatus 21 transmits packets during the transmission phase to optimize the efficacy of the wireless/wired network 23 in transmitting packet trains. It should be noted that, although the first packet train 50, the second packet train 51, the third packet train 52 and the fourth packet train 53 in the second embodiment are described to comprise only the first packets 501, 511, 521, 531, the second packets 502, 512, 522, 532 and the third packets 503, 513, 523, 533, the number of packets in each of the first packet train 50, the second packet train 51, the third packet train 52 and the fourth packet train 53 is not limited in this invention. Those of ordinary skill in the art may devise themselves the number of packets in each of the first packet train 50, the second packet train 51, the third packet train 52 and the fourth packet train 53 based on the above descriptions, and this will not be further described herein.

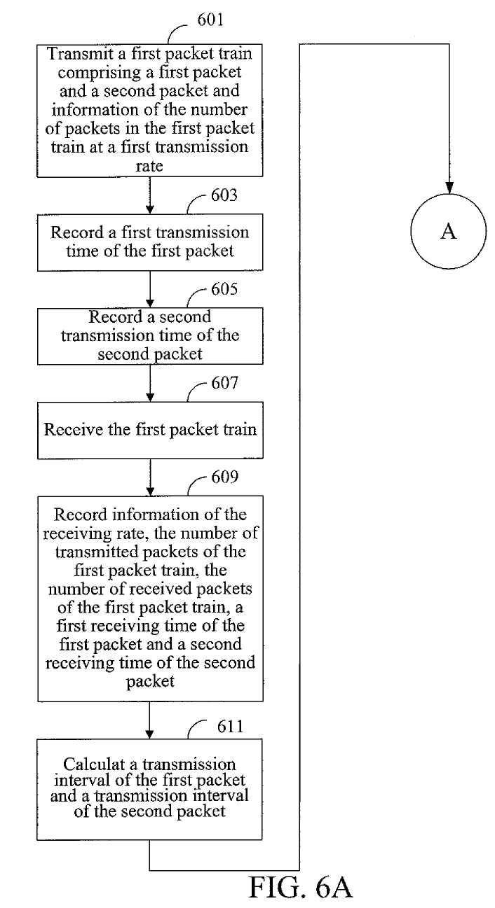

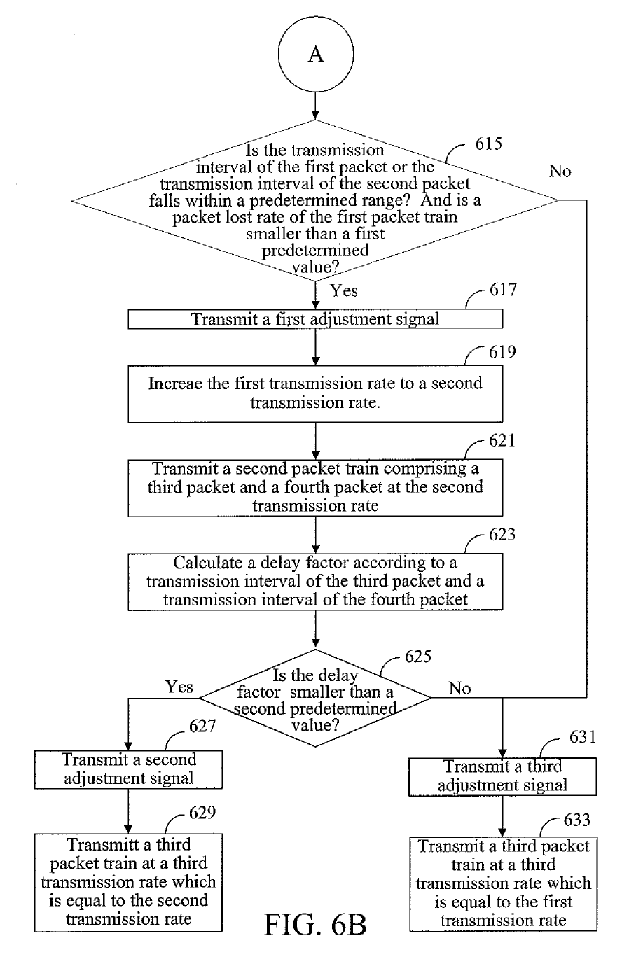

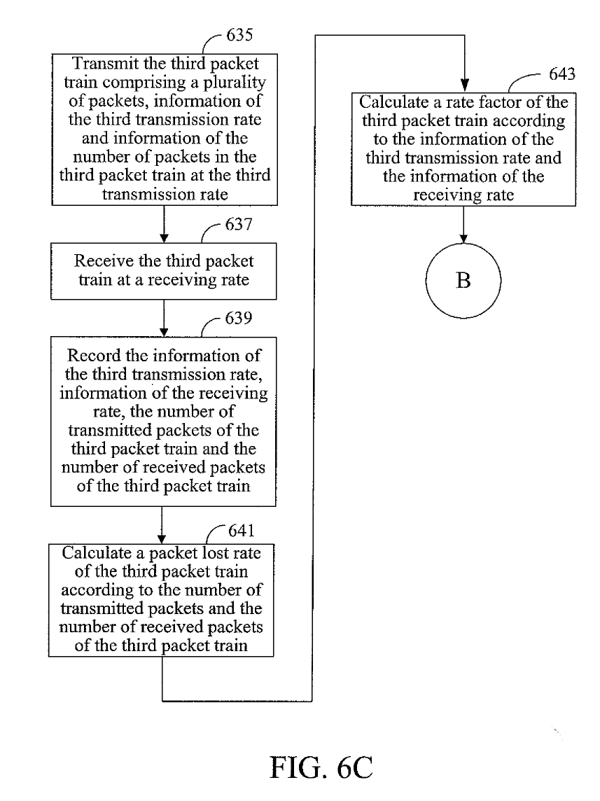

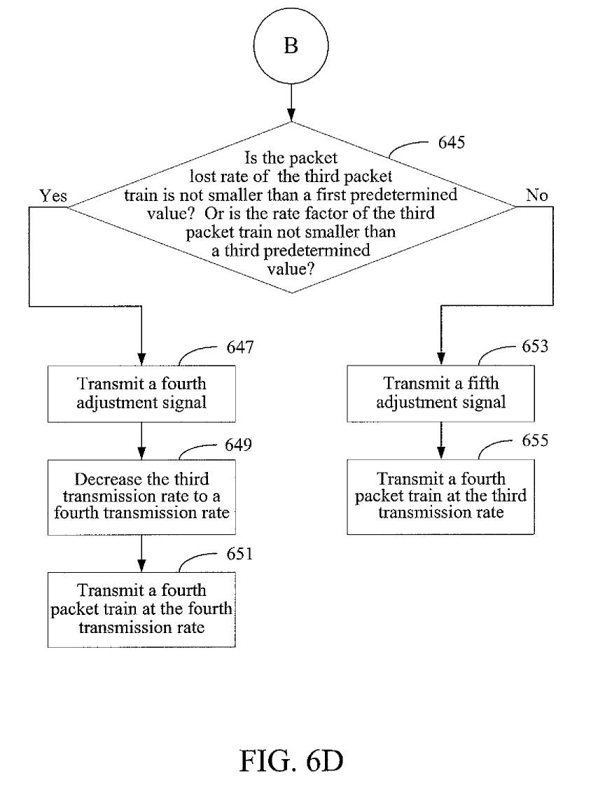

FIGS. 6A to 6D depict an adjusting method of a data transmission rate during the transmission phase, which is adapted for the network monitoring system 2 described in the second embodiment. More specifically, the adjustment method for the second embodiment may be executed by a computer program product. When the computer program product is loaded into the network monitoring system 2 via a computer to execute a plurality of program instructions embodied thereon, the adjustment method for the second embodiment can be accomplished. This computer program product may be stored in a tangible machine-readable medium, such as an ROM, a flash memory, a floppy disk, a hard disk, a compact disk, a mobile disk, a magnetic tape, a database accessible to networks, or any other storage media with the same function and well known to those skilled in the art.

The adjusting method of a data transmission rate during the transmission phase comprises the following steps. In reference to FIG. 6A, initially in Step 601, a first packet train with a plurality of packets and information of the number of packets transmitted in the first packet train are transmitted at a first transmission rate. Here, the first packet train has a first packet and a second packet, wherein the first packet and the second packet are both substantially incorporating audio/video data payload. Next, a first transmission time of the first packet is recorded via Step 603 and a second transmission time of the second packet is recorded in Step 605. Then, in Step 607, the first packet train is received. In Step 609, the number of packets transmitted in the first packet train, the number of packets received in the first packet train, a first receiving time of the first packet and a second receiving time of the second packet are recorded.

Next, in Step 611, a transmission interval of the first packet is calculated according to the first transmission time and the first receiving time of the first packet. A transmission interval of the second packet is also calculated according to the second transmission time and the second receiving time of the second packet via Step 611.

In reference to FIG. 6B, it is determined in Step 615 whether the transmission interval of the first packet or the transmission interval of the second packet falls within a predetermined range, and whether the packet lost rate of the first packet train is smaller than a first predetermined value. If it is determined in Step 615 that a first delay factor falls within the predetermined range and the packet lost rate of the first packet train is smaller than the first predetermined value, then a first adjustment signal is transmitted in Step 617. In response to the first adjustment signal, the first transmission rate is increased to a second transmission rate in Step 619.

In Step 621, a second packet train comprising a plurality of packets is transmitted at the second transmission rate. The second packet train comprises a third packet and a fourth packet, wherein the third packet and the fourth packet are both substantially incorporating audio/video data payload. Then, in Step 623, a delay factor is calculated according to a transmission interval of the third packet and a transmission interval of the fourth packet. In Step 625, it is determined whether the delay factor is smaller than a second predetermined value.

If it is determined in Step 625 that the delay factor is smaller than the second predetermined value, a second adjustment signal is transmitted in Step 627. In response to the second adjustment signal, a third packet train is transmitted in Step 629 at a third transmission rate, which is substantially the second transmission rate. Otherwise, if it is determined in Step 625 that the delay factor is not smaller than the second predetermined value, a third adjustment signal is transmitted via Step 631. Subsequently, in response to the third adjustment signal, a third packet train is transmitted via Step 633 at a third transmission rate, which is substantially the first transmission rate. On the other hand, if in Step 615, it is determined that the transmission interval of the first packet and the transmission interval of the second packet does not falls within a predetermined range, or the packet lost rate of the first packet train is not smaller than a first predetermined value, Steps 631 to 633 are executed.

In reference to FIG. 6C, in Step 635, a third packet train comprising a plurality of packets and information of the number of packets transmitted in the third packet train are transmitted at the third transmission rate. Then, in Step 637, the third packet train is received at a receiving rate. In Step 639, the information of the receiving rate, the number of transmitted packets of the third packet train and the number of received packets of the third packet train are recorded.

In Step 641, the packet lost rate of the third packet train is calculated according to the number of transmitted packets and the number of received packets in the third packet train. Next, in Step 643, a rate factor of the third packet train is calculated according to the information of the third transmission rate and the information of the receiving rate.

In reference to FIG. 6D, in Step 645, it is determined whether the packet lost rate of the third packet train is not smaller than the first predetermined value, or whether the rate factor of the third packet train is not smaller than a third predetermined value. If the result of Step 645 is positive, a fourth adjustment signal is transmitted in Step 647. Then, in response to the fourth adjustment signal, the third transmission rate is decreased to a fourth transmission rate in Step 649. Finally in Step 651, a fourth packet train is transmitted at the fourth transmission rate.

If it is determined in Step 645 that the packet lost rate of the third packet train is smaller than the first predetermined value, and the rate factor of the third packet train is smaller than a third predetermined value, a fifth adjustment signal is transmitted in Step 653. In response to the fifth adjustment signal, the fourth packet train is transmitted continuously at the third transmission rate in Step 655.

In summary, according to the network system, through the adjusting methods of the data transmission rate during the initial phase and the transmission phase respectively and the computer program products thereof disclosed in this invention, a heavy cross traffic condition can be detected in a real-time manner by means of the time information. The data transmission rate at the transmitting end can also be adjusted according to the information that is originally transmitted. In this way, the problem with the solution of the prior art, which required a large amount of network bandwidth resources to adjust the data transmission rate of the transmitting end according to the network conditions, can be prevented.

The above disclosure is related to the detailed technical contents and inventive features thereof People skilled in this table may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An adjusting method of a data transmission rate, comprising the steps of:
transmitting a first packet train comprising a plurality of packets at a first transmission rate, wherein the first packet train comprises a first packet and a second packet;
receiving the first packet train at a receiving rate;
recording the information of the receiving rate;
calculating the information of the first transmission rate;
calculating a packet lost rate of the first packet train;
transmitting a first adjustment signal at least partially based on the information of the first transmission rate, the information of the receiving rate and the packet lost rate of the first packet train; and
adjusting the first transmission rate as a second transmission rate in response to the first adjustment signal, wherein the second transmission rate and the first transmission rate are different.

2. The adjusting method of claim 1, further comprising the steps of:
recording a first transmission time of the first packet;
recording a second transmission time of the second packet;
recording a first receiving time of the first packet and a second receiving time of the second packet after receiving the first packet train;
calculating a transmission interval of the first packet according to the first transmission time and the first receiving time; and
calculating a transmission interval of the second packet according to the second transmission time and the second receiving time.

3. The adjusting method of claim 1, further comprising the step of:
recording the number of received packets and the number of transmitted packets of the first packet train upon receiving the first packet train;
wherein the packet lost rate of the first packet train is calculated according to the number of transmitted packets and the number of received packets in the first packet train.

4. The adjusting method of claim 2, wherein the step of transmitting the first adjustment signal further comprises the steps of:
comparing the transmission interval of the first packet with a predetermined range;
comparing the transmission interval of the second packet with the predetermined range; and
comparing the packet lost rate of the first packet train with a first predetermined value;
wherein when the transmission interval of the first packet and the transmission interval of the second packet falls within the predetermined range, and the packet lost rate of the first packet train is smaller than the first predetermined value, the second transmission rate is increased to be higher than the first transmission rate in response to the first adjustment signal.

5. The adjusting method of claim 4, wherein the step of adjusting the first transmission rate as the second transmission rate further comprises the steps of:
transmitting a second packet train comprising a plurality of packets at the second transmission rate, wherein the second packet train comprises a third packet and a fourth packet;
receiving the second packet train;
calculating a delay factor according to a transmission interval of the third packet and a transmission interval of the fourth packet;
comparing the delay factor with a second predetermined value;
transmitting a second adjustment signal when the delay factor is smaller than the second predetermined value; and
transmitting a third packet train at the second transmission rate in response to the second adjustment signal.

6. The adjusting method of claim 5, wherein the step of adjusting the first transmission rate as the second transmission rate further comprises the steps of:
transmitting a third adjustment signal when the delay factor is not smaller than the second predetermined value; and
transmitting the third packet train at the first transmission rate in response to the third adjustment signal.

7. The adjusting method of claim 1, wherein the step of transmitting the first adjustment signal further comprises the step of:
comparing the packet lost rate of the first packet train with a first predetermined value;
wherein if the packet lost rate of the first packet train is greater than the first predetermined value, the second transmission rate is decreased to be lower than the first transmission rate in response to the first adjustment signal.

8. The adjusting method of claim 7, further comprising the step of:
transmitting a second packet train at the second transmission rate.

9. The adjusting method of claim 1, wherein the step of transmitting the first adjustment signal further comprises the steps of:
calculating a rate factor of the first packet train according to the information of the first transmission rate and the information of the receiving rate; and
comparing the rate factor of the first packet train with a third predetermined value;
wherein if the rate factor of the first packet train is greater than the third predetermined value, the second transmission rate is decreased to be lower than the first transmission rate in response to the first adjustment signal.

10. The adjusting method of claim 9, further comprising the steps of:
transmitting a second packet train at the second transmission rate.

11. A computer program product having instructions for adjusting a data transmission rate, the computer program product being loaded into a network via a computer to execute instructions of:
a first instruction, transmitting a first packet train comprising a plurality of packets at a first transmission rate, wherein the first packet train comprises a first packet and a second packet;
a second instruction, receiving the first packet train at a receiving rate;
a third instruction, recording the information of the receiving rate;
a fourth instruction, calculating the information of the first transmission rate;
a fifth instruction, calculating a packet lost rate of the first packet train;
a sixth instruction, transmitting a first adjustment signal at least partially based on the information of the first transmission rate, the information of the receiving rate and the packet lost rate of the first packet train; and
a seventh instruction, adjusting the first transmission rate as a second transmission rate in response to the first adjustment signal, wherein the second transmission rate and the first transmission rate are different.

12. The computer program product of claim 11, further comprising:
an eighth instruction, recording a first transmission time of the first packet;
a ninth instruction, recording a second transmission time of the second packet;
a tenth instruction, recording a first receiving time of the first packet and a second receiving time of the second packet after receiving the first packet train;
an eleventh instruction, calculating a transmission interval of the first packet according to the first transmission time and the first receiving time; and
a twelfth instruction, a transmission interval of the second packet according to the second transmission time and the second receiving time.

13. The computer program product of claim 11, further comprising:
an eighth instruction, recording the number of received packets and the number of transmitted packets of the first packet train upon receiving the first packet train;
wherein the packet lost rate of the first packet train is calculated according to the number of transmitted packets and the number of received packets in the first packet train.

14. The computer program product of claim 12, wherein the sixth instruction further comprises:
a thirteenth instruction, comparing the transmission interval of the first packet with a predetermined range;
a fourteenth instruction, comparing the transmission interval of the second packet with the predetermined range; and
a fifteenth instruction, comparing the packet lost rate of the first packet train with a first predetermined value;
wherein when the transmission interval of the first packet and the transmission interval of the second packet falls within the predetermined range, and the packet lost rate of the first packet train is smaller than the first predetermined value, the second transmission rate is increased to be higher than the first transmission rate in response to the first adjustment signal.

15. The computer program product of claim 14, wherein the seventh instruction further comprises:
a sixteenth instruction, transmitting a second packet train comprising a plurality of packets at the second transmission rate, wherein the second packet train comprises a third packet and a fourth packet;
a seventeenth instruction, receiving the second packet train;
an eighteenth instruction, calculating a delay factor according to a transmission interval of the third packet and a transmission interval of the fourth packet;
a nineteenth instruction, comparing the delay factor with a second predetermined value;
a twentieth instruction, transmitting a second adjustment signal when the delay factor is smaller than the second predetermined value; and
a twenty first instruction, transmitting a third packet train at the second transmission rate in response to the second adjustment signal.

16. The computer program product of claim 15, wherein the seventh instruction further comprises:
a twenty second instruction, transmitting a third adjustment signal when the delay factor is not smaller than the second predetermined value; and
a twenty third instruction, transmitting the third packet train at the first transmission rate in response to the third adjustment signal.

17. The computer program product of claim 11, wherein the sixth instruction further comprises:
an eighth instruction, comparing the packet lost rate of the first packet train with a first predetermined value;
wherein if the packet lost rate of the first packet train is greater than the first predetermined value, the second transmission rate is decreased to be lower than the first transmission rate in response to the first adjustment signal.

18. The computer program product of claim 17, further comprising:
a ninth instruction, transmitting a second packet train at the second transmission rate.

19. The computer program product of claim 11, wherein the sixth instruction further comprises:
an eighth instruction, calculating a rate factor of the first packet train according to the information of the first transmission rate and the information of the receiving rate; and
a ninth instruction, comparing the rate factor of the first packet train with a third predetermined value;
wherein if the rate factor of the first packet train is greater than the third predetermined value, the second transmission rate is decreased to be lower than the first transmission rate in response to the first adjustment signal.

20. The computer program product of claim 19, further comprising:
a tenth instruction, transmitting a second packet train at the second transmission rate.

21. A network system, comprising:
a transmitting apparatus, being configured to transmit a first packet train comprising a plurality of packets at a first transmission rate, wherein the first packet train comprises a first packet and a second packet; and
a receiving apparatus, being configured to receive the first packet train at a receiving rate, record the information of the receiving rate, calculate the information of the first transmission rate, calculate a packet lost rate of the first packet train, and transmit a first adjustment signal to the transmitting apparatus at least partially based on the information of the first transmission rate, the information of the receiving rate and the packet lost rate of the first packet train;
wherein the transmitting apparatus adjusts the first transmission rate as a second transmission rate in response to the first adjustment signal, wherein the second transmission rate and the first transmission rate are different.

22. The network system of claim 21, wherein each of the first packet and the second packet has a time table, the transmitting apparatus records a first transmission time of the first packet in the time table of the first packet upon transmitting the first packet, and records a second transmission time of the second packet in the time table of the second packet upon transmitting the second packet, wherein the receiving apparatus records a first receiving time of the first packet and a second receiving time of the second packet after receiving the first packet train, then calculates a transmission interval of the first packet according to the first transmission time and the first receiving time, and calculates a transmission interval of the second packet according to the second transmission time and the second receiving time.

23. The network system of claim 21, wherein the receiving apparatus records the number of received packets in the first packet train and the number of transmitted packets of the first packet train upon receiving the first packet train, and calculates the packet lost rate of the first packet train according to the number of transmitted packets and the number of received packets of the first packet train.

24. The network system of claim 22, wherein the receiving apparatus is further configured to store a predetermined range and a first predetermined value, and the receiving apparatus compares the transmission interval of the first packet with the predetermined range, compares the transmission interval of the second packet with the predetermined range, and compares the packet lost rate of the first packet train with the first predetermined value after receiving the first packet train, wherein when the transmission interval of the first packet and the transmission interval of the second packet falls within the predetermined range, and the packet lost rate of the first packet train is smaller than the first predetermined value, the transmitting apparatus increases the second transmission rate to be higher than the first transmission rate in response to the first adjustment signal.

25. The network system of claim 24, wherein the receiving apparatus is further configured to store a second predetermined value, and the transmitting apparatus transmits a second packet train comprising a plurality of packets to the receiving apparatus at the second transmission rate after receiving the first adjustment signal, and the second packet train comprises a third packet and a fourth packet, wherein the receiving apparatus calculates a delay factor according to a transmission interval of the third packet and a transmission interval of the fourth packet, compares the delay factor with the second predetermined value after receiving the second packet train, and when the delay factor is smaller than the second predetermined value, the receiving apparatus transmits a second adjustment signal to the transmitting apparatus, so that the transmitting apparatus transmits a third packet train at the second transmission rate in response to the second adjustment signal.

26. The network system of claim 25, wherein when the delay factor is not smaller than the second predetermined value, the receiving apparatus transmits a third adjustment signal to the transmitting apparatus, so that the transmitting apparatus transmits the third packet train at the first transmission rate in response to the third adjustment signal.

27. The network system of claim 21, wherein the receiving apparatus is configured to store a first predetermined value, and compares the packet lost rate of the first packet train with the first predetermined value after receiving the first packet train, when the packet lost rate of the first packet train is greater than the first predetermined value, the transmitting apparatus decreases the second transmission rate to be lower than the first transmission rate in response to the first adjustment signal and transmits a second packet train at the second transmission rate.

28. The network system of claim 21, wherein the information of the receiving rate is recorded, and the receiving apparatus is further configured to store a third predetermined value, and the receiving apparatus calculates a rate factor of the first packet train according to the information of the first transmission rate and the information of the receiving rate wherein after receiving the first packet train, the receiving apparatus compares the rate factor of the first packet train with the third predetermined value, and when the rate factor of the first packet train is greater than the third predetermined value, the transmitting apparatus decreases the second transmission rate to be lower than the first transmission rate in response to the first adjustment signal and transmits a second packet train at the second transmission rate.

29. An adjusting method of a data transmission rate, comprising the steps of:
transmitting a first packet train comprising a plurality of packets at a first transmission rate, wherein the first packet train comprises a first packet and a second packet;
receiving the first packet train at a receiving rate;
calculating a delay factor according to a transmission interval of the first packet and a transmission interval of the second packet;
comparing the delay factor with a predetermined value;
transmitting an adjustment signal when the delay factor is greater than the predetermined value; and
adjusting the first transmission rate as a second transmission rate in response to the adjustment signal, wherein the second transmission rate is the same as the receiving rate.

30. The adjusting method of a data transmission rate of claim 29, further comprising the steps of:
recording a first transmission time of the first packet;
recording a second transmission time of the second packet; and
recording a first receiving time of the first packet and a second receiving time of the second packet after receiving the first packet train;
wherein the transmission interval of the first packet is a difference between the first transmission time and the first receiving time, and the transmission interval of the second packet is a difference between the second transmission time and the second receiving time.

31. A computer program product having instructions for adjusting a data transmission rate, the computer program product being loaded into a network system via a computer to execute instructions of:
a first instruction, transmitting a first packet train comprising a plurality of packets at a first transmission rate, wherein the first packet train comprises a first packet and a second packet;
a second instruction, receiving the first packet train at a receiving rate;
a third instruction, calculating a delay factor according to a transmission interval of the first packet and a transmission interval of the second packet;
a fourth instruction, comparing the delay factor with a predetermined value;
a fifth instruction, transmitting an adjustment signal when the delay factor is greater than the predetermined value; and
a sixth instruction, adjusting the first transmission rate as a second transmission rate in response to the adjustment signal, wherein the second transmission rate is the same as the receiving rate.

32. The computer program product of claim 31 further comprising:
a seventh instruction, recording a first transmission time of the first packet;
an eighth instruction, recording a second transmission time of the second packet; and
a ninth instruction, recording a first receiving time of the first packet and a second receiving time of the second packet after having received the first packet train;
wherein the transmission interval of the first packet is a difference between the first transmission time and the first receiving time, and the transmission interval of the second packet is a difference between the second transmission time and the second receiving time.

33. A network system, comprising:
a transmitting apparatus, being configured to transmit a first packet train comprising a plurality of packets at a first transmission rate, wherein the first packet train comprises a first packet and a second packet; and
a receiving apparatus, being configured to store a predetermined value, receive the first packet train at a receiving rate, calculate a delay factor according to a transmission interval of the first packet and a transmission interval of the second packet, compare the delay factor with the predetermined value, and when the delay factor is greater than the predetermined value, transmit an adjustment signal;
wherein, the transmitting apparatus adjusts the first transmission rate as a second transmission rate in response to the adjustment signal, and the second transmission rate is the same as the receiving rate.

34. The network system of claim 33, wherein each of the first packet and the second packet has a time table, and the transmitting apparatus records a first transmission time of the first packet in the time table of the first packet when transmitting the first packet, and records a second transmission time of the second packet in the time table of the second packet when transmitting the second packet, wherein the receiving apparatus records a first receiving time of the first packet and a second receiving time of the second packet after receiving the first packet train, and calculates a transmission interval of the first packet according to the first transmission time and the first receiving time, and calculates a transmission interval of the second packet according to the second transmission time and the second receiving time.
